(19) United States
(12) Patent Application Publication
(10) Pub. No.: US 2004/0194036 A1
(43) Pub. Date: Sep. 30, 2004

(54) Automated evaluation of overly repetitive word use in an essay

(76) Inventors: Magdalena Wolska, Saarbrucken (DE); Jill Burstein, Princeton, NJ (US)

Correspondence Address: Pepper Hamilton LLP, Firm 21269, One Mellon Center, 50th Floor, 500 Grant Street, Pittsburgh, PA, 15219, US

(21) Appl. No.: 10/713,863

(22) Filed: Nov. 14, 2003

Related U.S. Application Data
(60) Provisional application No. 60/426,015, filed on Nov. 14, 2002.

(51) Int. Cl. G06F 17/00

(52) U.S. Cl. 715/531

(57) ABSTRACT

To automatically evaluate an essay for overly repetitive word usage, a word is identified in the essay and at least one feature associated with the word is determined. In addition, a probability of the word being used in an overly repetitive manner is determined by mapping the feature to a model. The model having been generated by a machine learning application based on at least one evaluated essay. Furthermore, the essay is annotated to indicate the word is used in an overly repetitive manner in response to the probability exceeding a threshold probability.

This application claims priority to United States Provisional Application Serial No. 60/426,015, filed Nov. 14, 2002 and entitled “AUTOMATED EVALUATION OF OVERLY REPETITIVE WORD USE IN AN ESSAY”.

### BACKGROUND

Practical writing experience is generally regarded as an effective method of developing writing skills. In this regard, literature pertaining to the teaching of writing suggests that evaluation and feedback, specifically pointing out strong and weak areas in a students essay writing, may facilitate improvements in the student's writing abilities, specifically with regard to essay organization.

In traditional writing classes, an instructor may evaluate a students' essay. This evaluation may include comments directed to specific elements of the essay. Similarly, with the advent of automated essay evaluation, a computer application may be configured to evaluate an essay and provide feedback. This process may be relatively straight forward with respect to certain writing errors. For example, the spellings of words may be readily compared against a list of correctly spelled words. Any words not found in the list may be presented as incorrectly spelled. In another example, errors in subject-verb agreement may be identified based on a corpus of annotated essays. These essays having been annotated by trained human judges (e.g., writing teachers, and the like) and utilized to build a sufficiently large database to train the evaluation software. This training method may be substantially successful for recognizing writing errors where there is a relatively high degree of agreement among judges.

In contrast to the relatively “hard and fast” errors presented above such as grammar errors or incorrect spelling, errors in writing style, including using a word too frequently within an essay text, may be more subjective in nature. Judges may not agree on which style is best. Some judges may be distracted by certain stylistic choices while other judges are not. Because these types of errors are difficult to define, they may prove most vexing to a writing student.

Therefore, the present method of evaluating an essay satisfies the need to generate feedback on one of the subjective elements writing style to student authors. Specifically, the present methods allow automatic evaluation of an essay to indicate which words are being excessively used within the essay text. Even though this evaluation may sometimes be subjective in human graders, the present invention provides an accurate evaluation method which predicts human evaluation of whether words are excessively used in an essay text. Human evaluations are therefore used as models to evaluate a student essay for writing style errors. Feedback about word overuse is helpful in refining a student's vocabulary skills in writing.

### SUMMARY OF THE INVENTION

In accordance with an embodiment, the invention provides a method for automatically evaluating an essay for overly repetitive word usage. In this method, a word is identified in the essay and one or more features associated with the word are determined. In addition, a probability of the word being used in an overly repetitive manner is determined by mapping the features to a model. The model having been generated by a machine learning application based on at least one human-evaluated essay. Furthermore, the essay is annotated to indicate that the word is used in an overly repetitive manner in response to the probability exceeding a threshold probability.

### BRIEF DESCRIPTION OF THE DRAWINGS

Embodiments of the invention are illustrated by way of example and not limitation in the accompanying figures in which like numeral references refer to like elements, and wherein:

FIG. 1 is a block diagram of a computer network in which an embodiment of the invention may be implemented;

FIG. 2 is a block diagram of a computer system in which an embodiment of the invention may be implemented;

FIG. 3 is a block diagram of an architecture for an automated evaluation application according to an embodiment of the invention;

FIG. 4 is a diagram of a model according to an embodiment of the invention;

FIG. 5 is a block diagram of an architecture for an automated evaluation application according to another embodiment of the invention;

FIG. 6 is a flow diagram of a method of evaluating an essay according to an embodiment of the invention;

FIG. 7 is a block diagram of an architecture for an embodiment of an automated evaluation model builder application;

FIG. 8 is a flow diagram of a method for building an overly repetitive word use model according to an embodiment of the invention; and

FIG. 9 is a flow diagram of a method for generating evaluated data according to an embodiment of the invention.

### DETAILED DESCRIPTION

For simplicity and illustrative purposes, the principles of the invention are described by referring mainly to an embodiment thereof. In the following description, numerous specific details are set forth in order to provide a thorough understanding of the invention. It will be apparent however, to one of ordinary skill in the art, that the invention may be practiced without limitation to these specific details. In other instances, well known methods and structures have not been described in detail so as not to unnecessarily obscure the invention.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications mentioned herein are incorporated by reference. Nothing herein is to be construed as an admission that the invention is not entitled to antedate such disclosure by virtue of prior invention.

In the following description various embodiments of an automated essay evaluation system, along with methods of construction and use are provided. The examples hereinbelow refer to a particular writing error, namely the use of words in an overly repetitive manner. In general, the term “overly repetitive” refers to a stylistic writing error in which a word, phrase, or the like, is repeated with sufficient frequency as to be distracting and/or objectionable to a reader. However, it is to be understood that the invention is not limited to the evaluation of overly repetitive word use. Instead, other embodiments of the invention may be utilized to detect a variety of writing errors.

The Examples of the present invention will be used to illustrate the agreement between human evaluators as to stylistic writing errors. This agreement is then used to generate a model to automatically evaluate essays for overly repetitive word usage.

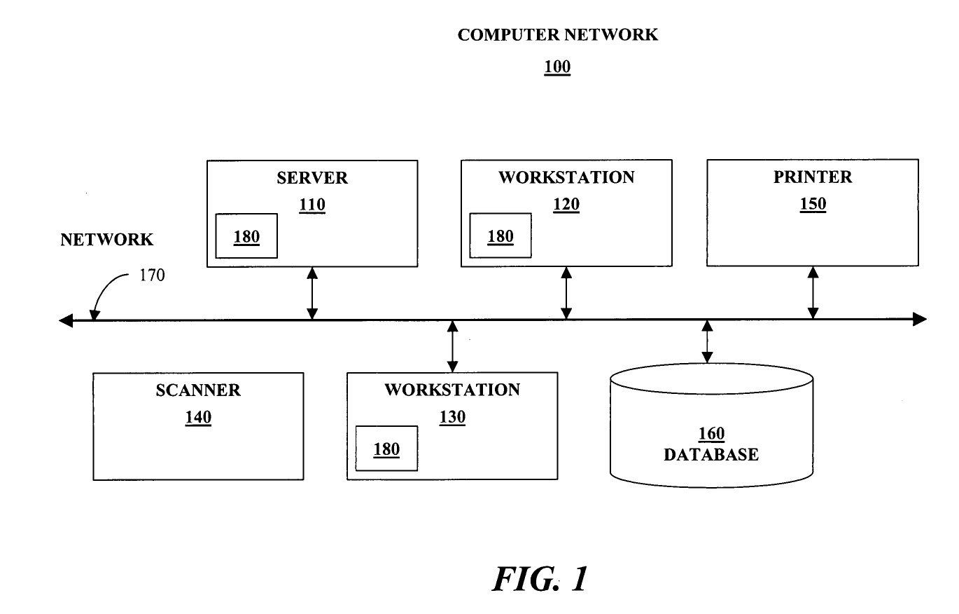

FIG. 1 is a block diagram of a computer network 100 in which an embodiment of the invention may be implemented. As shown in FIG. 1, the computer network 100 includes, for example, a server 110, workstations 120 and 130, a scanner 140, a printer 150, a database 160, and a computer network 170. The computer network 170 is configured to provide a communication path for each device of the computer network 100 to communicate with the other devices. Additionally, the computer network 170 may be the Internet, a public switched telephone network, a local area network, private wide area network, wireless network, and the like.

In an embodiment of the invention, an automated evaluation application (“AEA”) 180 may be executed on the server 110 and accessible thereon by either or both of the workstations 120 and 130. For example, in this embodiment of the invention, the server 110 is configured to execute the AEA 180, receive essays from the workstations 120 and 130 as input to the AEA, and output the results to the workstations 120 and/or 130. In an alternate embodiment, one or both of the workstations 120 and 130 may be configured to execute the AEA 180 individually or co-operatively.

The scanner 140 may be configured to scan textual content and output the content in a computer readable format. Additionally, the printer 150 may be configured to output the content to a print media, such as paper. Furthermore, the database 160 may be configured to store data associated with the AEA 180 such as essays, models for use by the AEA 180, results of the AEA's 180 processing and annotated essays. The database 160 may additionally be configured to deliver data to or receive data from the various components of computer network 100. Moreover, although shown in FIG. 1 as a system of distinct devices, some or all of the devices comprising computer network 100 may be subsumed within a single device.

Although FIG. 1 depicts the AEA 180 on a computer network 100, it is to be understood that the invention is not limited to operation within a network, but rather, the invention may be practiced in any suitable electronic device. Accordingly, the computer network depicted in FIG. 1 is for illustrative purposes only and thus is not meant to limit the invention in any respect.

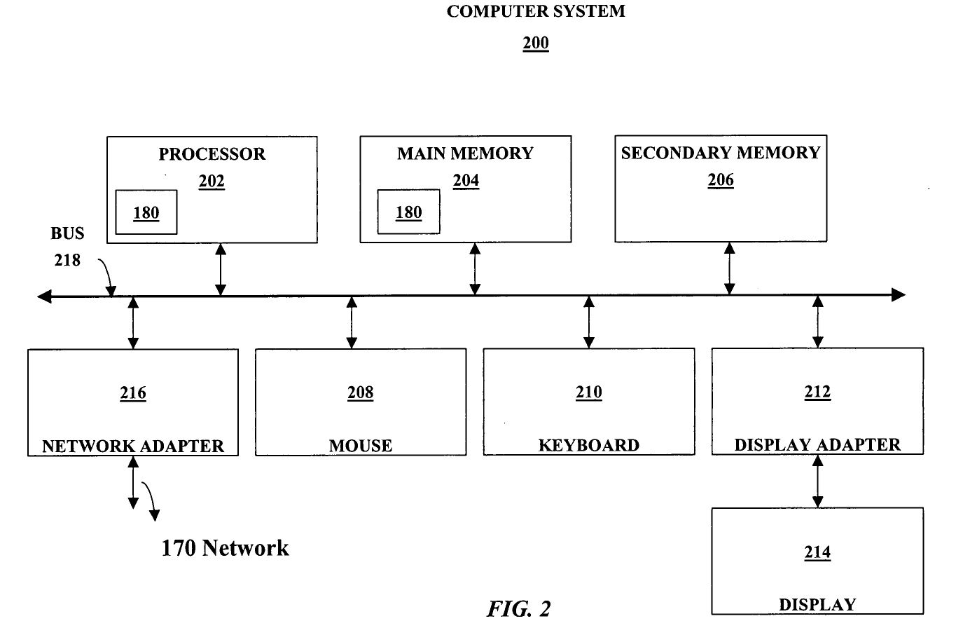

FIG. 2 is a block diagram of a computer system 200 in which an embodiment of the invention may be implemented. As shown in FIG. 2, the computer system 200 includes a processor 202, a main memory 204, a secondary memory 206, a mouse 208, a keyboard 210, a display adapter 212, a display 214, a network adapter 216, and a bus 218. The bus 218 is configured to provide a communication path for each element of the computer system 200 to communicate with the other elements.

The processor 202 is configured to execute a software embodiment of the AEA 180. In this regard, a copy of computer executable code for the AEA 180 may be loaded in the main memory 204 for execution by the processor 202 from the secondary memory 206. In addition to computer executable code, the main memory 204 and/or the secondary memory may store data, including essays, textual content, annotated essays, tables of data, essay scores, and the like.

In operation, based on the computer executable code for an embodiment of the AEA 180, the processor 202 may generate display data. This display data may be received by the display adapter 212 and converted into display commands configured to control the display 214. Furthermore, in a well known manner, the mouse 208 and keyboard 210 may be utilized by a user to interface with the computer system 200.

The network adapter 216 is configured to provide two way communication between the network 170 and the computer system 200. In this regard, the AEA 180 and/or data associated with the AEA 180 may be stored on the computer network 100 and accessed by the computer system 200.

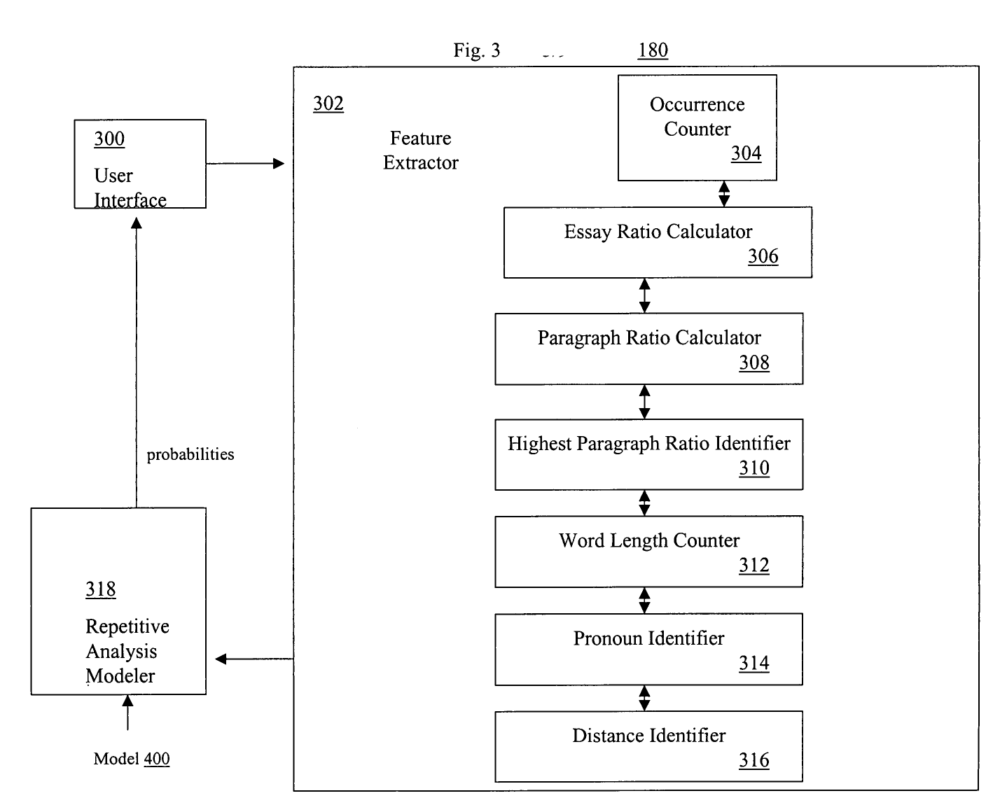

FIG. 3 is a block diagram of an architecture for the AEA 180 according to an embodiment of the invention. As shown in FIG. 3, the AEA 180 includes a user interface 300 configured to display essay questions, accept an essay and/or to output an evaluated (e.g., scored, annotated, commented, and the like) essay to the user. For example, the user interface 300 may display a question prompting the user to enter an essay. The user interface 300 may further accept an essay keyed into the keyboard 210, forward the essay to a feature extractor 302, and receive one or more probabilities from a repetitive analysis modeler 318. Moreover, the user interface may be configured to compare the one or more probabilities to a model, annotate the essay based on the comparison, and display an evaluated essay on the display 214. The threshold probability has been empirically determined to yield evaluations having a relative high agreement to human judges. The Examples will detail the agreement among human judges and between the human judges and the present automated evaluation system. The annotations may include any suitable indication of overly repetitive word use. For example, each instance of a word determined to be overly repeated may be displayed in bold type.

The feature extractor 302 includes a occurrence counter 304, a essay ratio calculator 306, paragraph ratio calculator 308, highest paragraph ratio identifier 310, word length counter 312, a pronoun identifier 314, and an interval distance identifier 316, each of which is configured to inter-communicate between each other. The term “feature” may be defined as an attribute, characteristic, and/or quality associated with an identified word. Furthermore, although the term “word” is used herein throughout, it is to be understood that the identification of overly repetitive words, a groups of words, phrases, and the like are within the scope of various embodiments of the invention.

The feature extractor 302 is configured to identify words within the essay and generate a vector file including a word entry for each identified word. The term vector file is used to describe an (MXI) matrix of feature values for each non-function word in the essay. To determine the words, the feature extractor 302 may parse the essay for one or more letters followed by a word separator such as a space, comma, period, or the like. Prior to generating the vector files, function words such as prepositions, articles, and auxiliary verbs, may be removed. For example, the function words (the, that, what, a, an, and, not) have been empirically found to increase the complexity of the analysis without contributing to the reliability of the result. In this regard, a list of function words is compared to the words in the essay. Words determined to match those in the list of function words may be removed and, as discussed hereinbelow, the vector file, similar to Table 1, may be generated from the remaining words.

Furthermore, as described hereinbelow, at least one feature may be determined and an associated value for each feature is stored in the entry. The word is determined as described above, and features are determined and associated for each word. In one embodiment, the features may be separated by commas. In other embodiments, the features may be associated via link list or some other relational data structure. In general, the features utilized have been empirically determined to be statistically relevant with respect to determining overly repetitive word usage. As will be described in greater detail hereinbelow in the Examples of the present invention, by modeling this particular combination of features, agreement between the AEA 180 and a human judge typically exceeds agreement between two human judges.

As an example, Table 1 shows the results of the feature extrater 302 which identified 7 features for each of 63 identified non-ftunction words in an essay. As shown in Table 1, each row of the table constitutes the feature vector for the given word.

TABLE 1

| Word | Ref. | 1 | 2 | 3 | 4 | 5 | 6 | 7 |
|---|---|---|---|---|---|---|---|---|
| did | 1, | 1, | 0.02, | 0.01, | 0.04, | 3, | 0, | N/A. |
| you | 2, | 4, | 0.06, | 0.03, | 0.17, | 3, | 0, | N/A. |
| ever | 3, | 1, | 0.02, | 0.01, | 0.04, | 4, | 0, | N/A |
| drive | 4, | 3, | 0.05, | 0.05, | 0.09, | 3, | 0, | N/A |
| | . | | | | | | | |
| | . | | | | | | | |
| | . | | | | | | | |
| always | 62, | 1, | 0.02, | 0.01, | 0.03, | 5, | 0, | N/A |
| signal | 63, | 2, | 0.03, | 0.01, | 0.05, | 4, | 0, | 17. |

As shown in Table 1, there are 63 vector files, one for each identified word in an essay minus the function words. In an embodiment of the invention, the first row represents a column header, the first column lists the identified words, the second column lists a reference word identifier, and the remainder of the columns list the associated values for the determined features. In various another embodiments, the column header, the list of identified words, and/or the reference word identifier may not be present. The values within the columns indicated above by column headers 1 to 7 are associated with features. In an embodiment of the invention, these features, listed in their respective order, are as follows.

1. The number of times the particular word is found in the essay, defined as “occurrences.”

2. The ratio of the occurrences as compared to the total number of words in the essay, defined as the “essay ratio.”

3. The average ratio of occurrences of the word within the individual paragraphs of the essay, defined as the “average paragraph ratio.” The particular word is counted within each essay paragraph and is divided by the number of words found in each paragraph to find an individual paragraph ratio. The average paragraph ratio is then stored as a feature here.

4. The “highest paragraph ratio” is determined for the highest proportional occurrence of the word within the individual paragraphs.

5. The “length of the word,” measured in individual letter characters is determined.

6. It is determined if the word is a pronoun by a “pronoun indicator” (Yes=1, No=0).

7. Finally, the “interval distance,” measured in words, in between occurrences of a particular word is determined for each word. This interval distance is not applicable and is not calculated if there is only one occurrence of the word in the essay. For each essay, the features are determined separately for each word, for each time the particular word appears in the text. Therefore, if the word “like” appears in the essay four times, four word vectors will be created for “like”. The first time “like” appears, there will be no “interval distance” to calculate. The second time the word appears however, this distance between the first and second occurrences will be calculated and stored in the feature set for the second occurrence of “like.”

In the example provided in Table 1, these 7 features are identified as being particularly useful in determining the overly repetitive use of a word in an essay. However, in practice, any reasonable number of features may be identified.

For example, the feature extractor may be configured to extract features on the parsed text based on total number of words found in the essay (e.g., token count) or based on the total number of different words appearing in the essay (e.g., type count.) The difference between token and type count is better understood with respect to the example used above. If the word “like” appeared four (4) times in the essay text, four vectors would be generated for the word “like” in a token count system. However, in a type count system, the feature extractor would generate only one vector for the word “like”.

As configured in Table 1, the feature extractor has extracted features based upon the total number of words in the essay (token count). For each and every word, a vector is generated and features determined. In another embodiment, the feature extractor may generate a feature vector for every different word in an essay (type count). In comparing a type count system to a token count system, the features displayed in column 1-7 would remain mostly equal in both systems. However, the interval distance calculation would change in a feature extractor based on type count. In a type count system, the interval distance feature may thus be configured to reflect the average distance, measured in words, found between word occurrences. The interval distance feature may also be figured to reflect the highest distance found between occurrences of the word. The interval distance may be calculated to reflect any such relationship between the distances in occurrences of the word. For example, if the word “like” occurred four (4) times in an essay text, with the distances of 4 words, 8 words, and 12 words appearing in between the four occurrences respectively, the average interval distance for the vector “like” would be 8 words.

For each word, the occurrence counter 304 is configured to determine the number of times the word appears in the essay (“occurrences”) and to store this value in the corresponding word entry (“entry”) in the vector file. For example, the word corresponding to a respective entry may be utilized as a “search string.” As the essay is searched, each “hit” to the search string may cause an occurrence counter (initially set to zero) to be incremented by one. An end of file (“EOF”) marker may be utilized to denote the end of the essay and thus, the storing of the value of the occurrence counter to the respective entry. The occurrence counter may be reset to zero and the number of occurrences for the next word may be counted. This process may continue until the occurrences of essentially all words have been determined and stored to their respective entries. The above example represents a relatively serial approach to the process of counting occurrences. However, it is within the scope of the invention that other approaches may be utilized. For example, essentially all of the occurrences for the words in the essay may be determined during an initial word identification parse of the essay.

The essay ratio calculator 306 is configured to determine a ratio of word use (“essay ratio”) for each word in the essay. In this regard, a total number of words (“word count”) present in the essay (minus any function words) is determined by the essay ratio counter 306. In addition, for each word, the essay ratio calculator 306 is configured to divide the occurrences by the word count to determine the essay ratio. The word count may be determined in a variety of manners. For example, the essay ratio calculator 306 may be configured to count the number of vector files or parse the essay for one or more letters followed by a word separator and, after removing the function words, determine a total number of words. The essay ratio may be stored with the associated word in the vector file by the essay ratio calculator 306.

The paragraph ratio calculator 308 is configured to determine the number of times each word appears in each paragraph, the number of words in each paragraph, and the ratio of occurrences per each paragraph. The average ratio of occurrences for paragraphs in the essay may be determined by calculating an average of the ratio of occurrences per each paragraph. The bounds of the paragraphs in the essay may be determined by locating hard return characters within the essay. The average ratio of occurrences for paragraphs in the essay may be stored with the associated word in the vector file by the paragraph ratio calculator 308. In addition, the paragraph ratio calculator 308 may be configured to forward the ratio of occurrences per each paragraph to the highest paragraph ratio identifier 310, in order to reduce duplication of labor.

The highest paragraph ratio identifier 310 is configured to receive the respective ratios of occurrences per each paragraph and identify the greatest value. This value may be stored with the associated word in the vector file as the highest paragraph ratio identifier 310.

The word length counter 312 is configured to determine the length of each respective word and store each respective length determination with the associated word in the vector file.

The pronoun identifier 314, is configured to identify pronouns in the essay. The pronoun identifier 314 is further configured to store a “1” for each respective entry in the vector file that is associated with an identified pronoun. In addition, the pronoun identifier 314 is configured to store a “0” for each respective entry in the vector file that is not associated with an identified pronoun. To identify any pronouns in the essay, each sentence in the essay is identified (e.g., based on period location) and words within each identified sentence are assigned a “part-of-speech tag” by a syntactic parser. The pronoun identifier 314, is configured to identify pronouns in the essay based on the “part-of-speech tags.” A more detailed description of the above-described syntactic parser may be found in U.S. Pat. No. 6,366,759 B1, filed Oct. 20, 2000, which is assigned to Educational Testing Service and is incorporated by reference herein in its entirety. Other methods of identifying pronouns may be used as well. For example, a predetermined list of pronouns may be compared to the parsed text to identify the pronouns in an essay.

The distance identifier 316 is configured to determine the number (if any) of intervening words separating a duplicated word from a proceeding occurrence of the word based on the essay and/or the vector file. During a first occurrence of the word, a distance of “N/A” is stored in the vector file for the word by the distance identifier 316. However, at a second (or greater) occurrence of a particular word, a numerical value representing the number of intervening words is determined and this value is stored in the vector file for the word (second or greater occurrence) by the distance identifier 316.

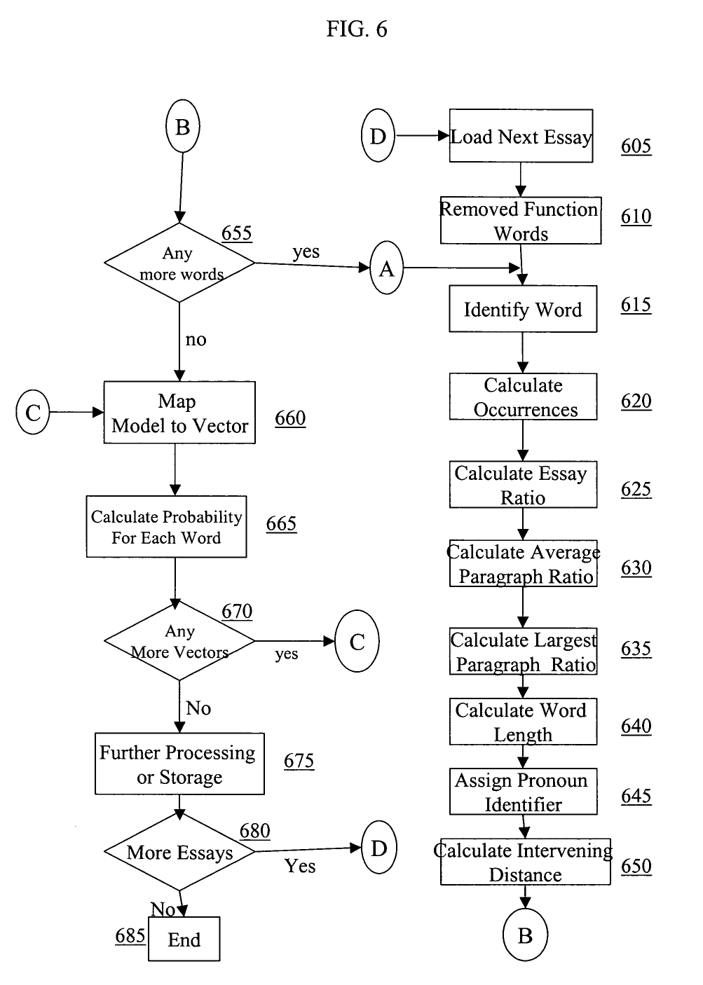

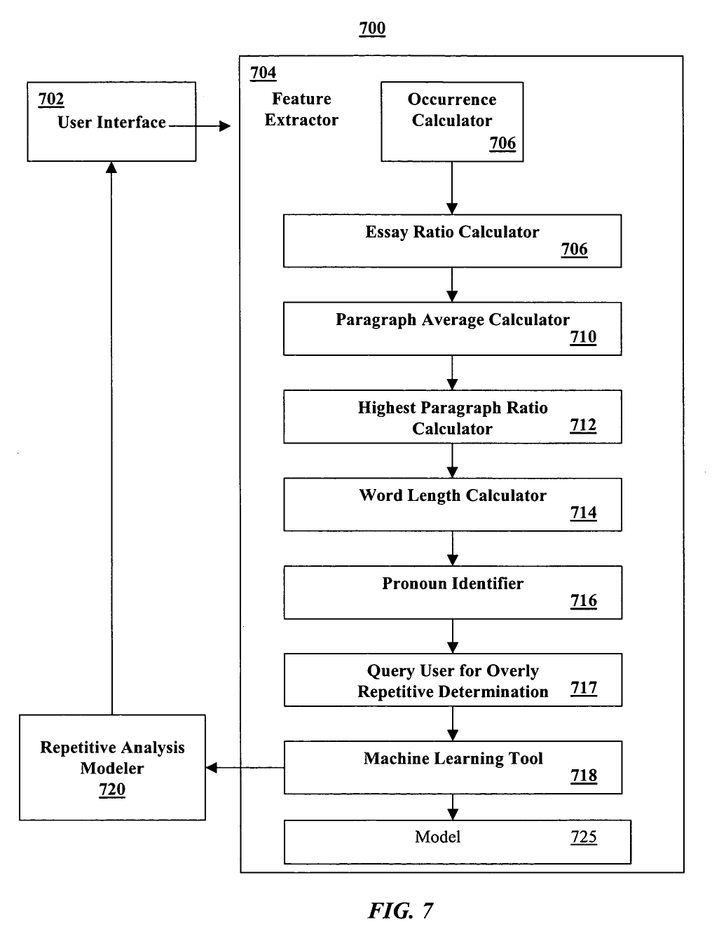

The repetitive analysis modeler 318 is configured to receive each of the vector files from the feature extractor 302 and extract patterns from the vector file, based on previous training (See FIG. 7). In the previous training, a model 400 is generated (See FIG. 6). In general, the model 400 includes at least one decision tree generated based on essays annotated by experts and/or trained judges. By navigating the decision tree based on the value and presence or absence of features associated with each entry in the vector file, a probability may be determined for each substantially unique word. This probability correlates the use of the word in the essay to overly repetitive word use. Thus, for each word, the model 400 is utilized to determine the likelihood of the word being overly repetitive (e.g., “mapping”). For example, as the vector file is mapped to the model 400, the probability of each word being overly repetitive is determined. In general, the process of mapping involves navigating a multi-branched decision tree called the model 400. At each branch in the decision tree, a value associated with a feature is utilized to determine how to proceed through the model. At the completion of the mapping process a probability is returned. This process may be repeated for each entry in the vector file and a probability may be returned for each entry. These probabilities may be forwarded to the user interface 300.

Modeling may also be accomplished by any other method in the art. Other methods include multiple regression to determine the weights of each feature to be used in the final calculation of whether a word is overly used. Modeling and human evaluation is again discussed in the Examples of the present application.

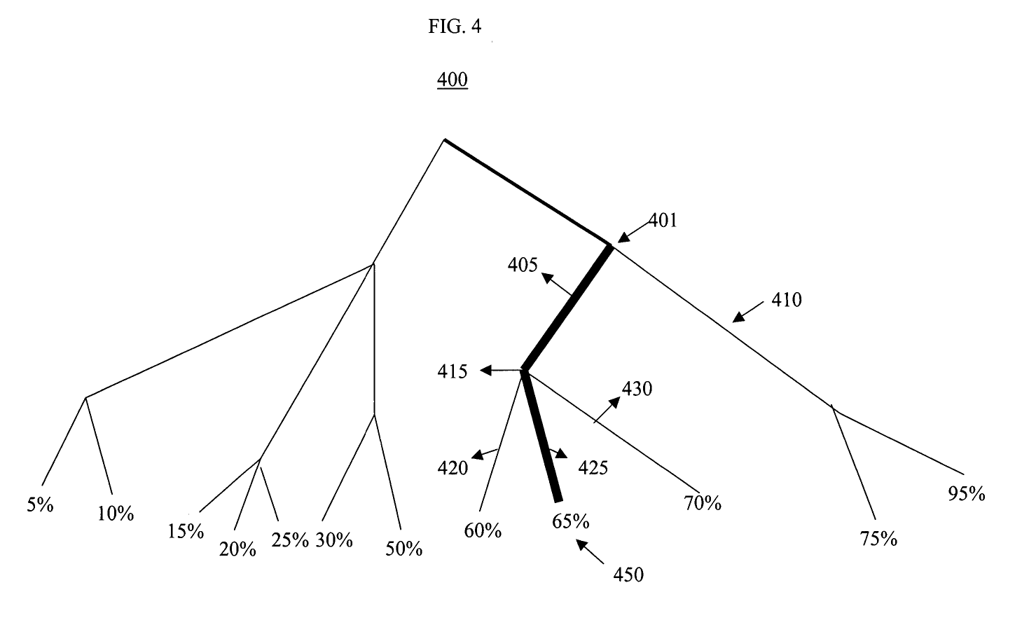

Each model is constructed from a plurality of essays scored by human graders. The feature values stored in the vector files for each word are compared to the value ranges which comprise the model. For example, in FIG. 4 a simplified representation of the model 400 as a decision tree is shown. At the first decision point 401, the occurrences value for a given word is compared to the model. If the occurrences value is within a particular range, branch 405 is taken; otherwise, branch 410 would be taken. A second decision point 415 is reached which may compare the essay ratio to the model. The value of the essay ratio may be compared to multiple ranges to determine which of paths 420, 425 or 430 may be taken. The various decision points and associated segments form a plurality of paths through the model 400. Each path has an associated probability. Based on the vector file, one path through the various segments may be determined and the associated probability may be returned. This process is depicted by a relatively thicker path 450. Thus, in this example, a probability of 65% may be returned.

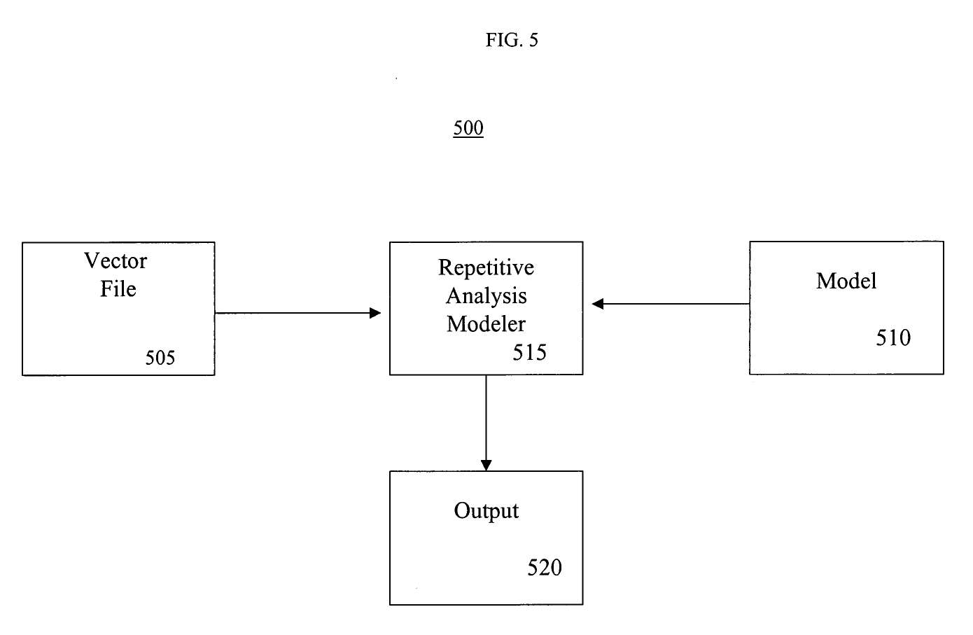

FIG. 5 is a block diagram of an architecture for an automated evaluation application (“AEA”) 500 according to an alternate embodiment of the invention. While not shown in FIGS. 1 or 2, the AEA 500 may be implemented on a computer system (e.g., the computer system 200) and/or over a computer network (e.g., the computer network 100). The AEA 500 of this embodiment is similar the embodiment depicted in FIG. 3 and thus, only aspects that differ will be discussed hereinbelow. One difference from the AEA 180 shown in FIG. 3 is that the AEA 500 may be operated in a substantially independent manner from the user interface 300 and/or the feature extractor 302. In this regard, as shown in FIG. 5, the AEA 500 includes a vector file 505, a model 510, and a repetitive analysis modeler 515.

The repetitive analysis modeler 515 of this embodiment is configured to generate an output 520 based on mapping the vector file 505 to the model 510. The repetitive analysis modeler 515, may be configured to retrieve the vector file 505 and the model 510 from memory (e.g., main memory 204, secondary memory 206, or some other storage device) for example. The output 520 may include one or more probabilities based on the mapping process.

FIG. 6 is a flow diagram of a method 600 for the AEA 500 shown in FIG. 5 according to an embodiment of the invention. Accordingly, the method 600 may be implemented on a computer system (e.g., the computer system 200) and/or over a computer network (e.g., the computer network 100). The method 600 is initiated 605 in response to receiving an essay to be evaluated by the AEA 500.

The next essay is then loaded into main memory 605 for a processing by the AEA 500. The AEA 500 removes all the function words from the essay 610 and identifies the first non-function word 615 to be analyzed. In this regard, the AEA 500 is adaptable to analyze essays on a word by word basis, or may be adapted for use in analyzing particular phrases or character sequences to determine the feature values associated therewith. As in the previous embodiment shown in FIG. 3, the AEA 500 then calculates the occurrences 620, and the essay ratio 625 which is the ratio of each word in the essay to the total number of words in the essay. The AEA next calculates the paragraph ratio 630. In calculating the average paragraph ratio 630, the number of time each word appears in each paragraph, the number of words in each paragraph and the ratio of occurrences per each paragraph may be determined. The average ratio of occurrences for each paragraph in the essay may further be determined. For example, if a particular word has paragraph ratios 0.01, 0.02, and 0.03 for each of three paragraphs, the average paragraph ratio is 0.02. Using the values for each paragraph ratio, the AEA next calculates the largest paragraph ratio 635. Next, the length of the word is determined by word length 640. Each of the foregoing calculated values are stored in a vector for the identified word. In addition, the vector will contain a pronoun identifier value 645 which may be a given value if the word is identified as a pronoun (e.g. 1) and the second value if the word is not identified as a pronoun (e.g. 0).

Finally, the intervening distance 650 between occurrence of the word is measured and the value recorded in the vector file for the word. For the first occurrence of the word, a null value is stored in the respective entry 650 in the vector file. However, as vector files are generated for the subsequent occurrences of the particular word, a numerical value representing the interval distance can be calculated and stored in the vector file for the particular word. This distance is the number of intervening words determined between the two subsequent occurrences.

The AEA next determines if there are additional words remaining to be analyzed 655 and, if so, the process is repeated beginning at step 615. If there are no additional words in the essay to be analyzed, the created vector files are then mapped to a model 660 and resulting probabilities calculated for the word 665. This process is repeated for each vector 670 and the resulting probabilities are delivered for further processing or storage 675. The further processing may include comparison of the calculated probabilities to threshold levels to determine whether any of the given words should be categorized as overly repetitive in the essay. In addition, the probabilities may be used to annotate the essay to indicate overly repetitive word use. If there are additional essays to be analyzed 680, the foregoing method is then repeated beginning at step 605, otherwise, the method ends 685.

FIG. 7 is a block diagram of an architecture for an embodiment of a repetitive analysis model builder (“model builder”) 700. While not shown in FIG. 1 and FIG. 2, the model builder 700 may be implemented on a computer system (e.g., the computer system 200) and/or over a computer network (e.g., the computer network 100). As shown in FIG. 7, the model builder 700 includes a user interface 702, a feature extractor 704, and a machine learning tool 718.

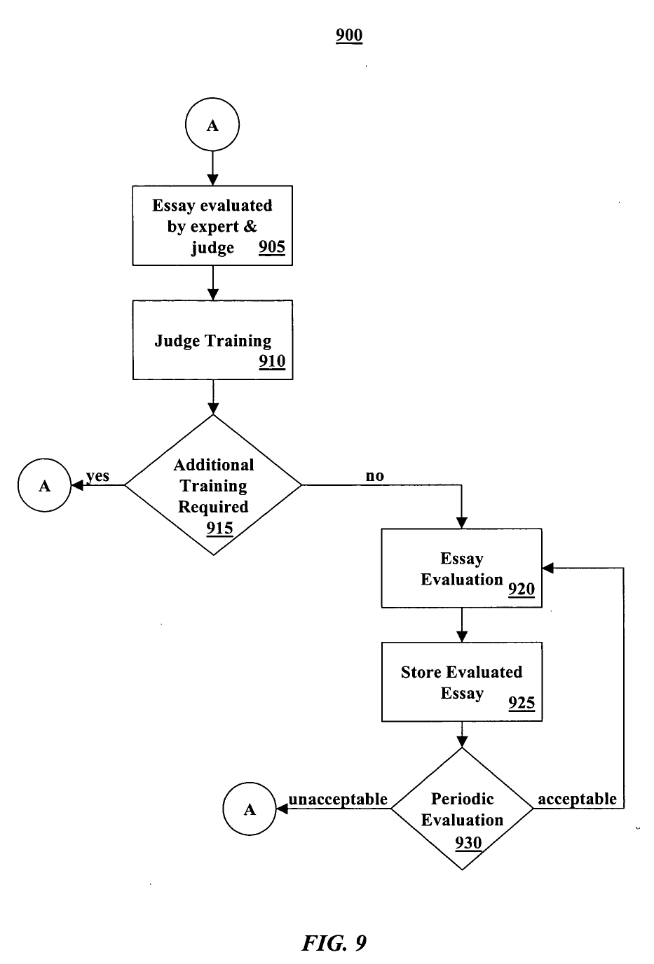

The user interface 702 is configured to accept training data. Training data which may comprise existing essays and annotations of the essays is utilized to build a repetitive analysis model. In this regard, the training data may be similar to the essay data described hereinabove. The training data may be essays written in response to a variety of test prompts. Therefore, the topic of the essay being evaluated may be different than the topic(s) of the essay training data used to generate the model. The annotations may include indicators of overly repetitive words within the training data. While the annotations may be generated in a variety of manners, in an embodiment of the invention, the user interface 702 is configured to accept manual annotations of the training data from a trained judge (See FIG. 9). Additionally, the user interface 702 is configured to forward the training data and/or the annotations to the feature extractor 704 and receive the created model 725 from the machine learning tool 718.

The feature extractor 704 of the model builder 700 is similar to the feature extractor 302 described hereinabove and thus only those features which are reasonably necessary for a complete understanding of the feature extractor 704 are described in detail herein below. As shown in FIG. 7, the feature extractor 704 comprises an occurrence counter 706, an essay ratio calculator 708, a paragraph ratio calculator 710, a highest paragraph ratio calculator 712, a word length counter 714, and a pronoun identifier 716, each of which operates as discussed more fully with respect to FIG. 3. The feature extractor 704 accepts the training data and/or annotations of the training data from the user interface 702 and calculates the associated feature values identified at 706, 708, 710, 712, 714 and 716, storing each value in a vector for the given word. Next, the user, for example a human evaluator, judge, or expert is queried 717 to enter a value (such as 1) to indicate the annotator's subjective determination of whether the word was used excessively or a second value (such as 0) to indicate the word was not used excessively. Alternatively, the training data essays have already been marked or annotated to indicate which words are used repetitively. At step 717, therefore, the feature extractor would read this annotation to determine repetitiveness of the words in the essay.

The machine learning tool 718 is configured use the features extracted from the training date to generate the model 725 based on this data. In general, the machine learning tool 718 is configured to determine patterns associated with each annotation. For example, the repetition of a relatively long word in relatively close proximity to the same word may be more strongly correlated than if the duplicated word is relatively short. In an embodiment of the invention, a machine learning tool (e.g., a data mining tool, etc.), C5.O™ (Available from RULEQUEST RESEARCH PTY. LTD., AUSTRALIA), is utilized to generate the model. However, in other embodiments of the invention, various other machine learning tools, and the like, may be utilized to generate the model and are thus within the scope of the invention. In this regard, in alternate embodiment of the invention, a plurality of models may be generated and incorporated into a single model. For example, a model based on word length, a model based on proximity, and a model based on ratio of occurrences in a paragraph may be generated. In this manner, a voting algorithm, for example, may receive candidate words (e.g., words likely to be overly repetitive) from each model and determine a consensus for each nominated word. The model 725 generated by the machine learning tool 718 is then incorporated into the repetitive analysis modeler 720 to be used to evaluate essays in the manner described herein.

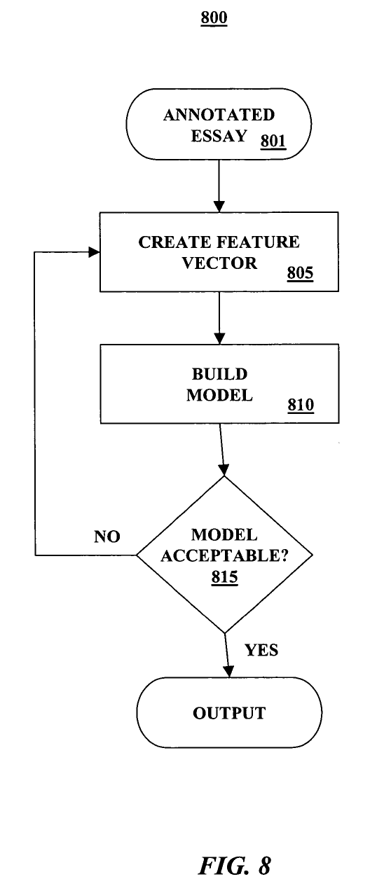

FIG. 8 is a flow diagram of a method 800 for building a model according to an embodiment of the invention. While not shown in FIGS. 1 or 2, the method 800 may be implemented on a computer system (e.g., the computer system 200) and/or over a computer network (e.g., the computer network 100). As shown in FIG. 8, the method 800 is initiated in response to receiving at least one annotated essay (e.g., annotated training data) 801. The annotated essay may be generated in a variety of manners, one of which is shown in FIG. 9. However, any method of generating annotated essays 801 is within the scope of the invention. In an embodiment of the invention, the annotated essays may be in the form of a plurality of essays discussing one or more topics. The plurality of essays having been annotated by one or more trained judges. In general, the annotations may be utilized to identify words used in an overly repetitive manner.

After receiving the at least one annotated essay 801, relevant features are extracted and stored in a vector 805 for each word. The features may be extracted by any method, including use of a feature extractor such as described in conjunction with FIG. 3 or FIG. 7. However, in this instance the features may be modified by a human evaluator to better represent relevant characteristics and parameters.

Once the feature vectors have been created 805, the model is built 810 by a machine learning tool examining the vector and the human annotated essay for patterns or other relevant characteristics. The model may be built by an method herein described such as the method described in FIG. 7 or by any other known method.

The model is then evaluated to determine whether it is sufficiently accurate in predicting results 815. For example, the model may be utilized in a method similar to the method discussed in conjunction with FIG. 3 to evaluate an essay. The essay may be evaluated 815 by a human expert and compared to its performance as the model 400 in the AEA 180. If the evaluations agree within a predetermined range, the model may be determined to be acceptable. If the evaluations fail to agree within a predetermined range, the model may fail and the method 800 may return to step 805 where the characteristics and parameters can be modified in an effort to increase the accuracy of the model.

FIG. 9 is a flow diagram of a method 900 for generating evaluated or annotated essays which can be used to generate a model according to an embodiment of the invention. As shown in FIG. 9, the method 900 begins with an expert and a judge receiving at least one essay to be evaluated 905. The expert may be one or more persons generally recognized as having greater than average skill in the art of grammar and/or essay evaluation. The judge may be one or more persons of at least ordinary skill in the art of grammar and/or essay evaluation.

At step 910, the judge is trained by the expert to annotate essays for overly repetitive word usage. For example, the expert may train or teach according to a predetermined set of rules for determining if a word is excessively used. Additionally, the judge may observe the expert evaluating one or more essays. The judge and expert may discuss how and why particular evaluations are made. If additional training is required 915 the process is repeated using additional essays. Otherwise, the judge is deemed trained to evaluate and/or annotate essays which can be used to generate models.

Next, essays are evaluated and/or annotated by the judge 920 based on training received at step 910. For example, the judge may identify words determined to be used in an overly repetitive manner and annotate the essay accordingly. These evaluated essays may be stored in a database or other data storage device 925.

Periodically, the performance of the judge is evaluated to determine whether essays are being evaluated and/or annotated in an acceptable manner 930. For example, essays evaluated by a first judge may be compared to evaluations, on the same essays, by a second judge and/or an expert. If the evaluations agree within a predetermined range, the performance may be deemed acceptable. A level of agreement between the evaluated essays may be determined, for example, by calculating values for one or more known characteristic measures of an evaluated essay such as: Kappa, precision, recall and F-measure. In this regard, Kappa is a generally known equation for determining a statistical probability of agreement, excluding the probability of chance. Precision is a measure of agreement between the first judge and the second judge, divided by the number of evaluations performed by the first judge. Recall is a measure of agreement between the first judge and the second judge, divided by the number of evaluations performed by the second judge. F-measure is equal to two times precision times recall, divided by the sum of precision plus recall.

If the performance of the judge is determined to be unacceptable, the judge may be returned to training with an expert. If the performance of the judge is determined to be acceptable, the judge may continue evaluating and/or annotating essays.

An embodiment of the invention 900 provides for the training of one or more judges in order to generate annotated essays for use in the model building. For example, if a relatively large number of essays are to be evaluated and doing so would be unduly burdensome to a relatively small number of experts, it may be advantageous to train a plurality of judges using method 900. In another embodiment of the invention, either a judge, trained judge or expert may evaluate essays.

The AEA, the model builder described herein, and the methods of the present invention may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form. Examples of computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the program(s) on a CD ROM or via Internet download. In a sense, the Internet itself, as an abstract entity, is a computer readable medium. The same is true of computer networks in general.

Additionally, some or all of the experts, judges, and users referred to herein may include software agents configured to generate essays, annotate essays, and/or teach judges to annotate essays. In this regard, the software agent(s) may exist in a variety of active and inactive forms.

### EXAMPLES

The following examples show the agreement among human evaluators and the agreement between the present system and human evaluators. Two human judges annotated a series of essays to indicate if any words were used excessively. The short-hand notation of “repeated” or “repetition” or “repetitive” refers to overly repetitive usage of a particular word in an essay.

The results in Table 2 show agreement between the two human judges based on essays marked for repetition by the judges, at the word level. This data in Table 2 includes cases where one judge annotated some repeated words and the other judge annotated no words as repeated. Each judge annotated overly repetitive word use in about 25% of the essays. In Table 2,“J1 with J2” agreement indicates that Judge 2 annotations were the basis for comparison; and,“J2 with J1” agreement indicates that Judge 1 annotations were the basis for comparison. The Kappa between the two judges was 0.5 based on annotations for all words (i.e., repeated+non-repeated). Kappa indicates the agreement between judges with regard to chance agreement. Kappa values higher than 0.8 reflect high agreement, between 0.6 and 0.8 indicate good agreement, and values between 0.4 and 0.6 show lower agreement, but still greater than chance.

TABLE 2
Precision, Recall, and F-measures Between
Judge 1(J1) and Judge 2 (J2)

| | | Precision | Recall | F-measure |
|---|---|---|---|---|
| J1 with J2¹ | 70 essays | | | |
| Repeated | 1,315 | 0.55 | 0.56 | 0.56 |
| words | | | | |
| Non-repeated | 42,128 | 0.99 | 0.99 | 0.99 |
| words | | | | |
| All words | 43,443 | 0.97 | 0.97 | 0.97 |
| J2 with J1² | 74 essays | | | |
| Repeated | 1,292 | 0.56 | 0.55 | 0.56 |
| words | | | | |
| Non-repeated | 42,151 | 0.99 | 0.99 | 0.99 |
| words | | | | |
| All words | 43,443 | 0.97 | 0.97 | 0.97 |

¹Precision = Total number J1 + J2 ÷ total number J1 labels; Recall = Total number J1 + j2 agreements ÷ total number J2 labels; F-measure = 2 * P * R ÷ (P + R)
²Prevision = Total number J1 + J2 agreements ÷ total number J2 labels; Recall = Total number J1 + J2 agreements ÷ total number J1 labels; F-measure = 2 * P * R ÷ (P + R)

In Table 2, agreement on “Repeated words” between judges is somewhat low. But there is a total set of essays identified by either judge as having some repetition, specifically, an overlapping set of 40 essays where both judges annotated the essay as having some sort of repetition. This overlap is a subset and is used to ultimately create the model of the invention. Of the essays that Judge 1 annotated as having some repetition, approximately 57% (40/70) of these essays matched the determination of Judge 2 that there was some sort of repetition; of the essays that Judge 2 annotated with repetitious word use, about 54% (40/74).

Focusing on the total number of “Repeated words” labeled by each judge for all essays in Table 2, this subset of 40 essays contains the majority of “Repeated words” for each judge: 64% (838/1315) for Judge 2, and 60% (767/1292) for Judge 1. Table 3 shows high agreement (J1 and J2 agree on the same words as being repetitious) between the two judges for “Repeated words” in the agreement subset. The Kappa between the two judges for “All words” (repeated+non-repeated) on this subset is 0.88.

TABLE 3
Precision, Recall, and F-measure Between
Judge 1 (J1) and Judge 2 (J2): “Essay-
Level Agreement Subset”

| | 40 essays | Precision | Recall | F-measure |
|---|---|---|---|---|
| J1 with J2 | | | | |
| Repeated | 838 | 0.87 | 0.95 | 0.91 |
| words | | | | |
| Non-repeated | 4,977 | 0.99 | 0.98 | 0.98 |
| words | | | | |
| All words | 5,815 | 0.97 | 0.97 | 0.97 |
| J2 with J1 | | | | |
| Repeated | 767 | 0.95 | 0.87 | 0.90 |
| words | | | | |
| Non-repeated | 5,048 | 0.98 | 0.99 | 0.98 |
| words | | | | |
| All words | 5,815 | 0.97 | 0.97 | 0.97 |

Table 4 shows agreement for repeated words between several baseline systems, and each of the two judges. Each baseline system uses one of the 7 word-based features used to select repetitive words (see Table 1). Baseline systems label all occurrences of a word as repetitious if the criterion value for the algorithm is met. After several iterations using different values, the final criterion value (V) is the one that yielded the highest performance. The final criterion value is shown in Table 4. Precision, Recall, and F-measures are based on comparisons with the same sets of essays and words from Table 2. Comparisons between Judge 1 with each baseline algorithm are based on the 74 essays where Judge 1 annotated the occurrence of repetitive words, and likewise, on the 70 essays where Judge 2 annotated the occurrence of repetitive words.

Using the baseline algorithms in Table 4, the F-measures for non-repeated words range from 0.96 to 0.97, and from 0.93 to 0.94 for all words (i.e., repeated+non-repeated words). The exceptional case is for Highest Paragraph Ratio Algorithm with Judge 2, where the F-measure for non-repeated words is 0.89, and for all words is 0.82.

To evaluate the system in comparison to each of the human judges, for each feature combination algorithm, a 10-fold cross-validation was run on each set of annotations for both judges. For each cross-validation run, a unique nine-tenths of the data were used for training, and the remaining one-tenth was used for cross-validating that model. Based on this evaluation, Table 5, shows agreement at the word level between each judge and a system that uses a different combination of features. Agreement refers to the mean agreement across the 10-fold cross-validation runs.

All systems clearly exceed the performance of the 7 baseline algorithms in Table 4. Building a model using the annotated sample from human judges 1 or 2 yielded indistinguishable, accurate results. For this reason, the data from either of the judges may be used to build the final system. When the All Features system is used, the F-measure=1.00 for non-repeated words, and for all words for both “J1 with System” and “J2 with System.” Using All Features, agreement for repeated words more closely resembles inter-judge agreement for the agreement subset in Table 3. The machine learning algorithm is therefore capturing the patterns of repetitious word use in the subset of essays, which the human judges agreed exhibited repetitiveness.

TABLE 4
Precision, Recall, and F-measures Between
Human Judges (J1 & J2) & Highest Baseline System
Performance for Repeated Words

| Baseline | | J1 with System | | | J2 with System | | |
|---|---|---|---|---|---|---|---|
| Systems | V | Precision | Recall | F-measure | Precision | Recall | F-measure |
| Absolute Count | 19 | 0.24 | 0.42 | 0.30 | 0.22 | 0.39 | 0.28 |
| Essay Ratio | 0.05 | 0.27 | 0.54 | 0.36 | 0.21 | 0.44 | 0.28 |
| Paragraph Ratio | 0.05 | 0.25 | 0.50 | 0.33 | 0.24 | 0.50 | 0.32 |
| Highest | 0.05 | 0.25 | 0.50 | 0.33 | 0.11 | 0.76 | 0.19 |
| Paragraph | | | | | | | |
| Ratio | | | | | | | |
| Word Length | 8 | 0.05 | 0.14 | 0.07 | 0.06 | 0.16 | 0.08 |
| Is Pronoun | 1 | 0.04 | 0.06 | 0.04 | 0.02 | 0.03 | 0.02 |
| Distance | 3 | 0.01 | 0.11 | 0.01 | 0.01 | 0.10 | 0.01 |

TABLE 3
Precision, Recall, and F-measure Between Human
Judges (J1 & J2) & 5 Feature Combination Systems for
Predicting Repeated Words

| | J1 with System | | | J2 with System | | |
|---|---|---|---|---|---|---|
| Feature Combination Algorithms | Precision | Recall | F-measure | Precision | Recall | F-measure |
| Absolute Count + | 0.95 | 0.72 | 0.82 | 0.91 | 0.69 | 0.78 |
| Essay Ratio + Paragraph | | | | | | |
| Ratio + Paragraph | | | | | | |
| Ratio (Count Features) | | | | | | |
| Count Features + Is Pronoun | 0.93 | 0.78 | 0.85 | 0.91 | 0.75 | 0.82 |
| Count Features + Word Length | 0.95 | 0.89 | 0.92 | 0.95 | 0.88 | 0.91 |
| Count Features + Distance | 0.95 | 0.72 | 0.82 | 0.91 | 0.70 | 0.79 |
| All Features: Count Features + Is | 0.95 | 0.90 | 0.93 | 0.96 | 0.90 | 0.93 |
| Pronoun + Word Length + | | | | | | |
| Distance | | | | | | |

Precision = Total judge + system agreements ÷ total system labels;
Recall = Total judge + system agreements ÷ total judge labels;
F-measure = 2 * P * R ÷ (P + R)

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, which is intended to be defined by the following claims and their equivalents in which all terms are meant in their broadest reasonable sense unless otherwise indicated.

We claim:

1. A method for automatically evaluating an essay to detect at least one writing style error, comprising:
electronically receiving an essay on a computer system;
assigning a feature value for each of one or more features for one or more text segments in the essay, wherein the feature values are automatically calculated by the computer system;
storing the feature values for the one or more text segments on a data storage device accessible by the computer system;
comparing the feature values for each one or more text segments with a model configured to identify at least one writing style error, wherein the model is based on at least one human evaluated essay; and
using the results of the comparison to the model to identify writing style errors in the essay.

2. The method according to claim 1 wherein the writing style error is the overly repetitive use of one or more text segments.

3. The method of claim 1 wherein the text segment comprises a word.

4. The method of claim 1 wherein the comparison step comprises extracting patterns from the feature values, wherein the patterns are based on the presence of absence of features associated with each word in the essay.

5. The method of claim 1, wherein the function words of the essay are not considered by the computer system in determining the feature values.

6. The method of claim 1 wherein the feature values comprise the total number of times the evaluated text segment occurs in the essay.

7. The method of claim 1 wherein the feature values comprise the ratio of the evaluated text segment occurrences in the essay to the total number of text segments in the essay.

8. The method of claim 1 wherein the feature values comprise the average, over all paragraphs of the essay, of the ratio of the number times the evaluated text segment occurs in a paragraph of the essay, over the total number of text segments in the paragraph.

9. The method of claim 1 wherein the feature values comprise the largest value of the ratio, of the number times the evaluated text segment occurs in a paragraph of the essay, over the total number of text segments in the paragraph, wherein the ratio is calculated for each paragraph in the essay.

10. The method of claim 1 wherein the feature values comprise the length, measured in characters, of the text segment.

11. The method of claim 1 wherein the feature values comprise a value indicating whether the text segment includes a pronoun.

12. The method of claim 1 wherein the feature values comprise a value representing the interval distance between consecutive text segment occurrences.

13. The method of claim 12 wherein the distance is determined by calculating the number of intervening words.

14. The method of claim 12 wherein the distance is determined by calculating the number of intervening characters.

15. The method of claim 1 wherein the model is generated using a machine learning tool.

16. A system for automatically evaluating an essay to detect at least one writing style error, comprising:
a computer system configured to electronically receive an essay;
a feature extractor configured to assign a feature value for each of one or more features for one or more text segments in the essay;
a data storage device, connected to the computer system, configured to store the feature values for the one or more text segments;
a feature analyzer configured to evaluate the essay for at least one writing style error by comparing the feature values for each one or more text segments with a model; and
a display for presenting the evaluated essay.

17. The system of claim 16 wherein the writing style error is the overly repetitive use of one or more text segments.

18. The system of claim 16 wherein the text segment comprises a word.

19. The system of claim 16, further comprising:
an annotator configured to annotate the essay to identify the one or more writing style errors.

20. The system of claim 16 wherein the feature extractor comprises an occurrences calculator configured to generate a value representing the total number of times the text segment occurs in the essay.

21. The system of claim 16 wherein the feature extractor comprises an essay ratio calculator configured to generate a value representing the ratio of the number of times the evaluated text segment occurs in the essay to the total number of text segments in the essay.

22. The system of claim 16 wherein the feature extractor comprises an average paragraph ratio calculator configured to generate a value representing the average over all paragraphs in the essay of the ratio of the number of times the evaluated text segment occurs in a paragraph of the essay over the total number of text segments in the paragraph.

23. The system of claim 16 wherein the feature extractor comprises a highest paragraph ratio calculator configured to generate a value representing the largest ratio of the number of times the evaluated text segment occurs in a paragraph of the essay over the total number of text segments in the paragraph.

24. The system of claim 16 wherein the feature extractor comprises a length calculator configured to generate a value representing the length, measured in characters, of the text segment.

25. The system of claim 16 wherein the feature extractor comprises an identifier to determine whether the text segment includes a pronoun.

26. The system of claim 16 wherein the feature extractor comprises a distance calculator configure to generate a value representing the distance between consecutive text segment occurrences.

27. The system of claim 26 wherein the distance between consecutive text segment occurrences is measured in words.

28. The system of claim 26 wherein the distance between consecutive text segment occurrences is measured in characters.

29. The system of claim 16 comprising a machine learning tool to generate the model.

30. The system of claim 16 where in the model is generated using at least one human evaluated essay.

31. A method for generating a model for determining overly repetitive text segment use, comprising:
electronically receiving training data on a computer system wherein the training data comprises an essay annotated to identify one or more text segments used in an overly repetitive manner;
assigning a feature value for each of one or more features for each text segment in the essay, wherein the feature values are automatically calculated by the computer system;
assigning an indicator value for each text segment in the essay, wherein the indicator value is set at a first value and if the text segment has been used in an overly repetitive manner;
storing the feature values and the indicator value for each text segment in the essay in a data storage device accessible by the computer system; and
creating a model for overly repetitive use of the one or more text segments in the essay by identifying patterns in the feature values wherein the patterns are identified by a machine learning tool.

32. The method of claim 31 wherein the text segment comprises a word.

33. The method of claim 31 wherein the annotations are manual markings.

34. The method of claim 31, wherein the function words of the essay are not considered by the computer system in calculating the feature values.

35. The method of claim 31 wherein the feature values comprise the total number of times the evaluated text segment occurs in the essay.

36. The method of claim 31 wherein the feature values comprise the ratio of the evaluated text segment occurrences in the essay to the total number of text segments in the essay.

37. The method of claim 31 wherein the feature values comprise the average over all paragraphs of the essay of the ratio of the number times the evaluated text segment occurs in a paragraph of the essay over the total number of text segments in the paragraph.

38. The method of claim 31 wherein the feature values comprise the largest value of the ratio of the number times the evaluated text segment occurs in a paragraph of the essay over the total number of text segments in the paragraph, wherein the ratio is calculated for each paragraph in the essay.

39. The method of claim 31 wherein the feature values comprise the length, measured in characters, of the text segment.

40. The method of claim 31 wherein the feature values comprise a value indicating whether the text segment includes a pronoun.

41. The method of claim 31 wherein the feature values comprise a value representing the interval distance between consecutive text segment occurrences.

42. The method of claim 41 wherein the distance is determined by calculating the number of intervening words.

43. The method of claim 41 wherein the distance is determined by calculating the number of intervening characters.

44. A system for generating a model useful in determining overly repetitive text segment use, comprising:
a computer system configured to receive training data, wherein the training data comprises an essay annotated to identify one or more text segments used in an overly repetitive manner;
a feature extractor configured to calculate a feature value for each of one or more features for each text segment in the essay and to assign an indicator value for each text segment in the annotated essay, wherein the indicator value indicates whether the text segment has been used in an overly repetitive manner;
a data storage device configured to store the feature values and the indicator value for each text segment in the essay;
a machine learning tool configured to analyze the features to identify patterns; and
a model builder to create a model for overly repetitive use of the text segments, wherein the model is constructed from the identified patterns.

45. The system of claim 44 wherein the annotated essays are manually marked.

46. The system of claim 44 wherein the feature extractor comprises an occurrences calculator configured to generate a value representing the total number of times the text segment occurs in the essay.

47. The system of claim 44 wherein the feature extractor comprises an essay ratio calculator configured to generate a value representing the ratio of the number of times the evaluated text segment occurs in the essay to the total number of text segments in the essay.

48. The system of claim 44 wherein the feature extractor comprises an average paragraph ratio calculator configured to generate a value representing the average over all paragraphs in the essay of the ratio of the number of times the evaluated text segment occurs in a paragraph of the essay over the total number of text segments in the paragraph.

49. The system of claim 44 wherein the feature extractor comprises a highest paragraph ratio calculator configured to generate a value representing the largest ratio of the number of times the evaluated text segment occurs in a paragraph of the essay over the total number of text segments in the paragraph.

50. The system of claim 44 wherein the feature extractor comprises a length calculator configured to generate a value representing the length, measured in characters, of the text segment.

51. The system of claim 44 wherein the feature extractor comprises an identifier to determine whether the text segment includes a pronoun.

52. The system of claim 44 wherein the feature extractor comprises a distance calculator configure to generate a value representing the distance between consecutive text segment occurrences.

53. The system of claim 52 wherein the distance between consecutive text segment occurrences is measured in words.

54. The system of claim 52 wherein the distance between consecutive text segment occurrences is measured in characters.
